(19) United States
(12) Patent Application Publication
(10) Pub. No.: US 2015/0011726 A1
(43) Pub. Date: Jan. 8, 2015

(54) DIAMINE, POLYIMIDE, AND POLYIMIDE FILM AND UTILIZATION THEREOF

(71) Applicant: KANEKA CORPORATION, Osaka (JP)

(72) Inventors: Masatoshi Hasegawa, Chiba (JP); Junichi Ishii, Chiba (JP)

(21) Appl. No.: 14/378,857

(22) PCT Filed: Feb. 4, 2013
(86) PCT No.: PCT/JP2013/052511

§ 371 Date: Aug. 14, 2014

(30) Foreign Application Priority Data
Feb. 16, 2012 (JP) 2012-031971

(51) Int. Cl. C08G 73/14

(52) U.S. Cl. CPC C08G 73/14
USPC 528/322; 564/157

(57) ABSTRACT

Provided are (i) a polyimide which is transparent and has an excellent solution processability, a high heat resistance, and a low linear thermal expansion coefficient, and (ii) a polyimide film of the polyimide. According to the present invention, it is possible to produce, by use of a novel diamine characterized in having an amide group and a trifluoromethyl group, the polyimide which is transparent and has the excellent solution processability, the high heat resistance, and the low linear thermal expansion coefficient. The polyimide can be applied to various electronic devices such as an electronic display device.

### TECHNICAL FIELD

The present invention relates to (i) a polyimide having a good solution processability, a low linear thermal expansion coefficient, and a high transparency, and (ii) a method of producing the polyimide. The present invention further relates to (i) a polyimide film of the polyimide, and (ii) a substrate, a color filter, an image display device, an optical material, and an electronic device, each of which includes the polyimide film. The present invention also relates to a diamine which is suitably used to produce the polyimide.

### BACKGROUND ART

In recent years, various display devices, such as a liquid crystal display and an organic EL display, employ a glass substrate. A glass substrate is an excellent material because of its high heat-resistance, low linear thermal expansion coefficient, and high transparency. On the other hand, these displays have been required to be lightweight and flexible. Therefore, a material to replace glass has been eagerly demanded. Various polyimide materials have been studied as the material which meets such demand.

Polyimide has a high heat resistance thanks to its chemical structure. However, polyimide has the following problems which make the polyimide unsuitable to be employed as a material to replace glass.

In a case where a polyimide is employed as a material to replace glass, particularly, in a case where the polyimide is employed as a material for use in a high-definition display device, the polyimide should have a low linear thermal expansion coefficient. However, it cannot be said that a typical polyimide film has such a low linear thermal expansion coefficient. The typical polyimide film has limited uses.

Moreover, most polyimides are colored due to transfer of electric charges in molecules and between molecules. It was therefore difficult to employ a polyimide film of the polyimides as a display material etc. which is required to have a high transparency.

Furthermore, since most polyimides do not dissolve in solvents, it is difficult to produce a uniform film of the polyimides by applying a solution of the polyimides. In order to produce a uniform polyimide film, widespreadly used is a method of (i) producing a uniform film of a polyamic acid which is a polyimide precursor which dissolves in a solvent and (ii) converting the film of the polyamic acid into a polyimide film. However, according to the method, it is necessary to heat the film of the polyamic acid at a temperature not lower than 300° C. so as to convert the film of the polyamic acid into the polyimide film. This causes a large shrinkage reaction. Therefore, the method has not only a problem of bending of the polyimide film due to a mismatch in linear thermal expansion coefficient between the polyimide film and a substrate but also a problem of film-defect due to water by-produced from the reaction.

In order to solve the problems, for example, Patent Literature 1 discloses a polyimide film which is transparent and colorless and has a high thermal stability. Patent Literature 2 discloses a dissolvable and transparent polyimide.

### CITATION LIST

### Patent Literatures

Patent Literature 1
Japanese Patent Application Publication (Translation of PCT Application), Tokuhyo, No. 2010-538103 A (Publication Date: Dec. 9, 2010)

Patent Literature 2
Japanese Patent Application Publication, Tokukai, No. 2011-225820 A (Publication Date: Nov. 10, 2011)

### SUMMARY OF INVENTION

### Technical Problem

However, a polyimide production method disclosed in Patent Literature 1 requires conversion of a polyimide precursor into a polyimide. Therefore, the above-described problem will be caused. Patent Literature 2 does not refer to a linear thermal expansion coefficient. Therefore, a polyimide solution described in Patent Literature 2 has limited uses in a case where a low linear thermal expansion coefficient is required. From the above viewpoints, a polyimide having a low linear thermal expansion coefficient, a high transparency, and en excellent solution processability was eagerly required.

The present invention was made to meet such an eager requirement, and an object of the present invention is to provide a polyimide which is transparent and has an excellent solution processability, a high heat resistance, and a low linear thermal expansion coefficient.

### Solution to Problem

As a result of diligent studies to attain the object, the object was attained by providing a polyimide which is characterized in being produced by use of a diamine represented by formula (1) below.

The following description will discuss the feature of the present invention.

1. A diamine represented by formula (1)

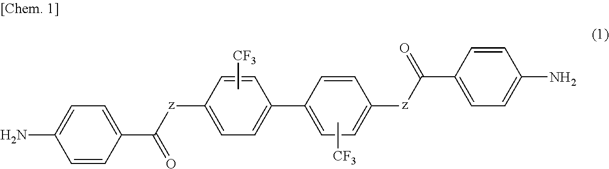

where z represents NH or O.

2. A polyamide having a repeating unit represented by formula (3)

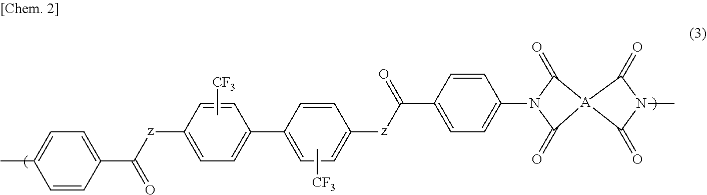

where A represents a tetravalent aliphatic group, and z represents NH or O.

### Advantageous Effects of Invention

According to the present invention, it is possible to provide a polyimide which is transparent and has an excellent solution processability, a high heat resistance, and a low linear thermal expansion coefficient. Note here that the term “transparent” herein means being colorless in appearance and having a light transmittance of not less than 60% at a wavelength of 400 nm.

### BRIEF DESCRIPTION OF DRAWINGS

FIG. 1 is a DSC chart diagram of a diamine of Example 1 of the present invention.

FIG. 2 is an IR spectrum diagram of the diamine of Example 1 of the present invention.

FIG. 3 is an NMR spectrum diagram of the diamine of Example 1 of the present invention.

FIG. 4 is a DSC chart diagram of a diamine of Example 5 of the present invention.

FIG. 5 is an IR spectrum diagram of the diamine of Example 5 of the present invention.

FIG. 6 is an NMR spectrum diagram of the diamine of Example 5 of the present invention.

### DESCRIPTION OF EMBODIMENTS

The following description will discuss in detail Embodiment of the present invention. It should be noted that the Embodiment is merely one aspect of the present invention, and the present invention is not limited to the Embodiment.

In order to reduce a linear thermal expansion coefficient of a polyimide, it is necessary to improve a molecular linearity and to enhance an intermolecular interaction. A polyimide of the present invention is characterized in being produced by use of a diamine represented by formula (1) below. The diamine has an intramolecular amide bonding or ester bonding. It is therefore considered that the polyimide produced by use of the diamine has linearly arranged molecules and a low linear thermal expansion coefficient.

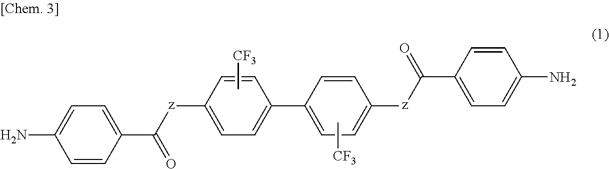

(where z represents NH or O)

Particularly, a diamine represented by formula (2) below is preferably employed as the diamine represented by formula (1). The diamine represented by formula (2) has an intramolecular amide bonding. It is therefore considered that a polyimide produced by use of the diamine represented by formula (2) has linearly arranged molecules and an intermolecular hydrogen bonding.

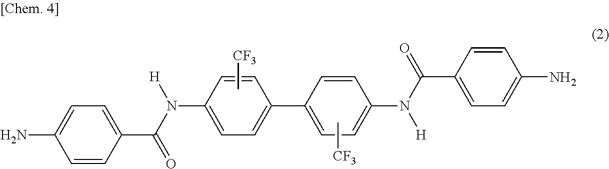

Particularly, in order to improve transparency, a diamine represented by formula (8) below is preferably employed as the diamine represented by formula (2).

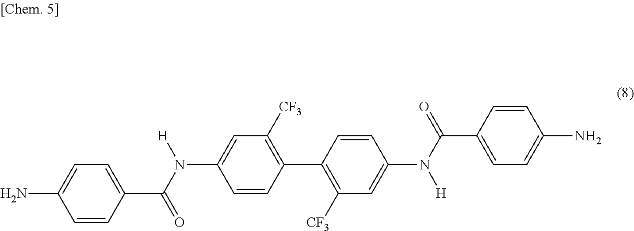 [SMILES: Nc1ccc(C(=O)Nc2ccc(-c3ccc(NC(=O)c4ccc(N)cc4)cc3C(F)(F)F)c(C(F)(F)F)c2)cc1]

A diamine represented by formula (9) below can be employed as the diamine represented by formula (1). The diamine represented by formula (9) has an intramolecular ester bonding. It is therefore considered that a polyimide produced by use of the diamine represented by formula (9) also has linearly arranged molecules.

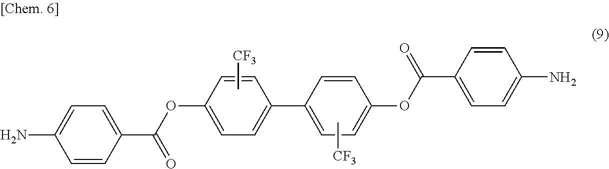

In order to improve transparency, a diamine represented by formula (10) below can be employed as the diamine represented by formula (9).

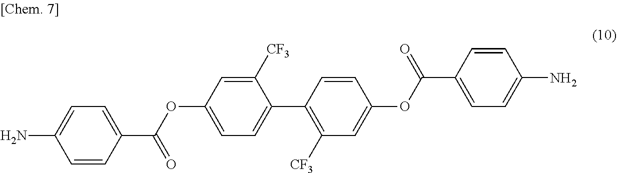 [SMILES: Nc1ccc(C(=O)Oc2ccc(-c3ccc(OC(=O)c4ccc(N)cc4)cc3C(F)(F)F)c(C(F)(F)F)c2)cc1]

In order to be dissolvable in a solvent, a polyimide should have a structure which allows molecules of the solvent to easily enter between molecular chains of the polyimide. The polyimide of the present invention is characterized in being produced by use of a diamine having a trifluoromethyl group. Since a trifluoromethyl group is three-dimensionally bulky, it is possible to prevent crystallization by introduction of the trifluoromethyl group. This makes it easy for the molecules of the solvent to enter between the molecular chains of the polyimide. Consequently, it is possible to obtain the polyimide which is dissolvable in a solvent.

Polyimide is colored in yellow to brown due to transfer of electric charges in and between molecules of the polyimide. In order to obtain a transparent polyimide, it is necessary to suppress such transfer of electric charges. Note here that “transparent” means being colorless in appearance and having a light transmittance of not less than 60% at a wavelength of 400 nm.

The transfer of electric charges can be suppressed by, for example, introducing an aliphatic skeleton into either one of or both of a tetracarboxylic dianhydride component and a diamine component each of which is a monomer used to synthesize a polyimide. An alicyclic tetracarboxylic dianhydride which can be used in polymerization of a polyimide precursor is not particularly limited. Examples of the alicyclic tetracarboxylic dianhydride include (1S,2R,4S,5R)-cyclohexanetetracarboxylic dianhydride (cis, cis, cis-1,2,4,5-cyclohexanetetracarboxylic dianhydride), (1S,2S,4R,5R)-cyclohexanetetracarboxylic dianhydride, (1R,2 S,4S,5R)-cyclohexanetetracarboxylic dianhydride, bicyclo[2.2.2]octane-2,3,5,6-tetracarboxylic dianhydride, bicyclo[2.2.2]octo-7-en-2,3,5,6-tetracarboxylic dianhydride, 5-(dioxo tetrahydro furyl-3-methyl)-3-cyclohexene-1,2-dicarboxylic anhydride, 4-(2,5-dioxotetrahydrofuran-3-yl)-tetralin-1,2-dicarboxylic anhydride, tetrahydrofuran-2,3,4,5-tetracarboxylic dianhydride, bicyclo-3,3′,4,4′-tetracarboxylic dianhydride, 1,2,3,4-cyclopentanetetracarboxylic dianhydride, 1,2,3,4-cyclobutanetetracarboxylic dianhydride, 1,3-dimethyl-1,2,3,4-cyclobutanetetracarboxylic dianhydride, and 1,4-dimethyl-1,2,3,4-cyclobutanetetracarboxylic dianhydride. Two or more kinds of these alicyclic tetracarboxylic dianhydrides may be used in combination.

From the viewpoint of the physical property and availability of a polyimide, a cyclohexanetetracarboxylic dianhydride represented by formula (11) below is preferably employed as the alicyclic tetracarboxylic dianhydride.

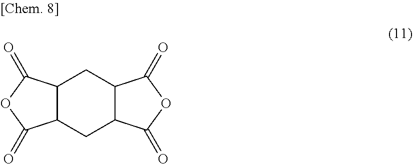 [SMILES: O=C1OC(=O)C2CC3C(=O)OC(=O)C3CC12]

In order to improve the linearity of polyimide molecules and reduce a linear thermal expansion coefficient, it is particularly preferable to employ, as the cyclohexanetetracarboxylic dianhydride, (1S,2S,4R,5R)-cyclohexanetetracarboxylic dianhydride whose three-dimensional structure is controlled and which is represented by formula (12) below.

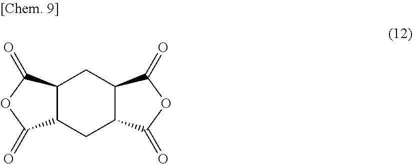

The diamine represented by formula (1) is used in the present invention. Another diamine can be used in combination with the diamine represented by formula (1). Examples of the another diamine include p-phenylenediamine, m-phenylenediamine, o-phenylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfone, 3,4′-diaminodiphenyl sulfone, 4,4′-diaminodiphenyl sulfone, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl)benzene, 2,6-bis(3-aminophenoxy)benzonitrile, 2,6-bis(3-aminophenoxy)pyridine, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 2,2-bis[4-(3-aminophenoxy)phenyl]propane, 2,2-bis[4-(4-aminophenoxy)phenyl)]propane, 1,3-bis[4-(3-aminophenoxy)benzoyl)]benzene, 1,3-bis[4-(4-aminophenoxy)benzoyl)]benzene, 1,4-bis[4-(3-aminophenoxy)benzoyl)]benzene, 1,4-bis[(4-(4-aminophenoxy)benzoyl)]benzene, 1,3-bis[4-(3-aminophenoxy)-α,α-dimethylbenzyl)]benzene, 1,3-bis[4-(4-aminophenoxy)-α,α-dimethylbenzyl]benzene, 1,4-bis[4-(3-aminophenoxy)-α,α-dimethylbenzyl)]benzene, 1,4-bis[4-(4-aminophenoxy)-α,α-dimethylbenzyl)]benzene, 4,4′-bis[4-(4-aminophenoxy)benzoyl]diphenyl ether, 4,4′-bis[(4-(4-amino-α,α-dimethylbenzyl)phenoxy]benzophenone, 4,4′-bis[4-(4-amino-α,α-dimethylbenzyl)phenoxy]diphenylsulfone, 4,4′-bis[4-(4-aminophenoxy)phenoxy]diphenylsulfone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-biphenoxybenzophenone, 6,6′-bis(3-aminophenoxy)-3,3,3′,3′-tetramethyl-1,1′-spirobiindane, 6,6′-bis(4-aminophenoxy)-3,3,3′,3′-tetramethyl-1,1′-spirobiindane, 1,3-bis(3-aminopropyl)tetramethyldisiloxane, 1,3-bis(4-aminobutyl)tetramethyldisiloxane, α,ω-bis(3-aminopropyl)polydimethylsiloxane, α,ω-bis(3-aminobutyl)polydimethylsiloxane, bis(aminomethyl)ether, bis(2-aminoethyl)ether, bis(3-aminopropyl)ether, bis[(2-aminomethoxy)ethyl]ether, bis[2-(2-aminoethoxy)ethyl]ether, bis[2-(3-aminoprothoxy)ethyl]ether, 1,2-bis(aminomethoxy)ethane, 1,2-bis(2-aminoethoxy)ethane, 1,2-bis[2-(aminomethoxy)ethoxy]ethane, 1,2-bis[2-(2-aminoethoxy)ethoxy]ethane, ethyleneglycol bis(3-aminopropyl)ether, diethyleneglycol bis(3-aminopropyl)ether, triethyleneglycol bis(3-aminopropyl)ether, ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,2-diaminocyclohexane, 1,3-diaminocyclohexane, 1,4-diaminocyclohexane, trans-1,4-diaminocyclohexane, 1,2-di(2-aminoethyl)cyclohexane, 1,3-di(2-aminoethyl)cyclohexane, 1,4-di(2-aminoethyl)cyclohexane, bis(4-aminocyclohexyl)methane, 2,6-bis(aminomethyl)bicyclo[2.2.1]heptane, 2,5-bis(aminomethyl) bicyclo[2.2.1]heptane, 1,4-diamino-2-fluorobenzene, 1,4-diamino-2,3-difluorobenzene, 1,4-diamino-2,5-difluorobenzene, 1,4-diamino-2,6-difluorobenzene, 1,4-diamino-2,3,5-trifluorobenzene, 1,4-diamino-2,3,5,6-tetrafluorobenzene, 1,4-diamino-2-(trifluoromethyl)benzene, 1,4-diamino-2,3-bis(trifluoromethyl)benzene, 1,4-diamino-2,5-bis(trifluoromethyl)benzene, 1,4-diamino-2,6-bis(trifluoromethyl)benzene, 1,4-diamino-2,3,5-tris(trifluoromethyl)benzene, 1,4-diamino-2,3,5,6-tetrakis(trifluoromethyl)benzene, 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′,3-trifluorobenzidine, 2,3,3′-trifluorobenzidine, 2,2′,5-trifluorobenzidine, 2,2′,6-trifluorobenzidine, 2,3′,5-trifluorobenzidine, 2,3′,6,-trifluorobenzidine, 2,2′,3,3′-tetrafluorobenzidine, 2,2′,5,5′-tetrafluorobenzidine, 2,2′,6,6′-tetrafluorobenzidine, 2,2′,3,3′,6,6′-hexafluorobenzidine, 2,2′,3,3′,5,5′,6,6′-octafluorobenzidine, 2-(trifluoromethyl)benzidine, 3-(trifluoromethyl)benzidine, 2,3-bis(trifluoromethyl)benzidine, 2,5-bis(trifluoromethyl)benzidine, 2,6-bis(trifluoromethyl)benzidine, 2,3,5-tris(trifluoromethyl)benzidine, 2,3,6-tris(trifluoromethyl)benzidine, 2,3,5,6-tetrakis(trifluoromethyl)benzidine, 2,3′-bis(trifluoromethyl)benzidine, 2,2′,3-bis(trifluoromethyl)benzidine, 2,3,3′-tris(trifluoromethyl)benzidine, 2,2′,5-tris(trifluoromethyl)benzidine, 2,2′,6-tris(trifluoromethyl)benzidine, 2,3′,5-tris(trifluoromethyl)benzidine, 2,3′,6-tris(trifluoromethyl)benzidine, 2,2′,3,3′-tetrakis(trifluoromethyl)benzidine, 2,2′,5,5′-tetrakis(trifluoromethyl)benzidine, and 2,2′,6,6′-tetrakis(trifluoromethyl)benzidine. However, the another diamine is not limited to these examples. An amount of the diamine represented by formula (1) to be used in copolymerization as early described (copolymer composition) is preferably not less than 10 mol % of a total amount of substance of diamine, more preferably not less than 50 mol % of the total amount of substance of diamine. In a case where the copolymer composition is not less than 10 mol % of the total amount of substance of diamine, it is possible to further prevent a linear thermal expansion coefficient, a solution processability, and a light transmittance from being deteriorated.

The polyimide of the present invention is characterized in being produced by use of the diamine represented by formula (1). A method of synthesizing the diamine represented by formula (1) is not limited to a specific one. The diamine represented by formula (1) can be synthesized by use of any means of a conventional synthesis method. Examples of a synthesis route include a method of (i) reacting a diamine and acid chloride with each other to obtain a dinitro compound which serves as a precursor and (ii) reducing the obtained dinitro compound with hydrogen in the presence of a catalyst (see formula (13)). According to, for example, the method represented by formula (13), it is possible to obtain the diamine represented by formula (2).

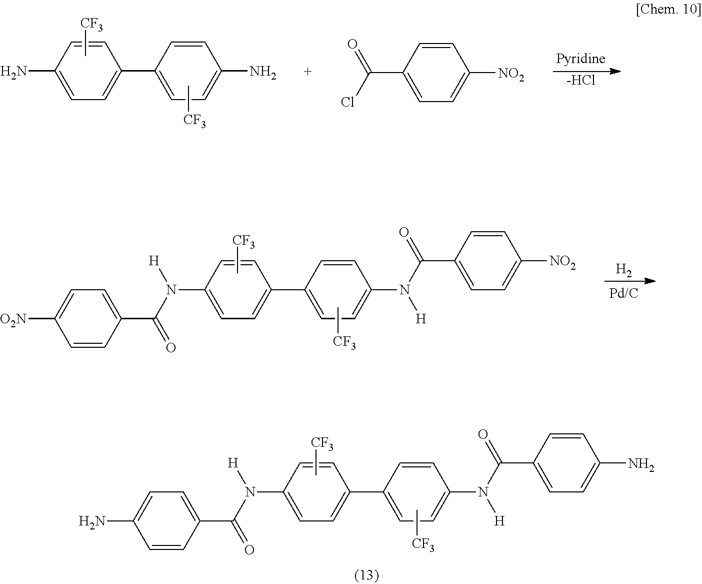

The examples of the synthesis route of the diamine represented by formula (1) further include a method of synthesizing an intermediate from a diamine (see formula (14)), then reacting the intermediate and acid chloride with each other to obtain a dinitro compound which serves as a precursor, and reducing the obtained dinitro compound with hydrogen in the presence of a catalyst (see formula (15)). According to the method represented by formulas (14) and (15), it is possible to obtain, for example, the diamine represented by formula (9).

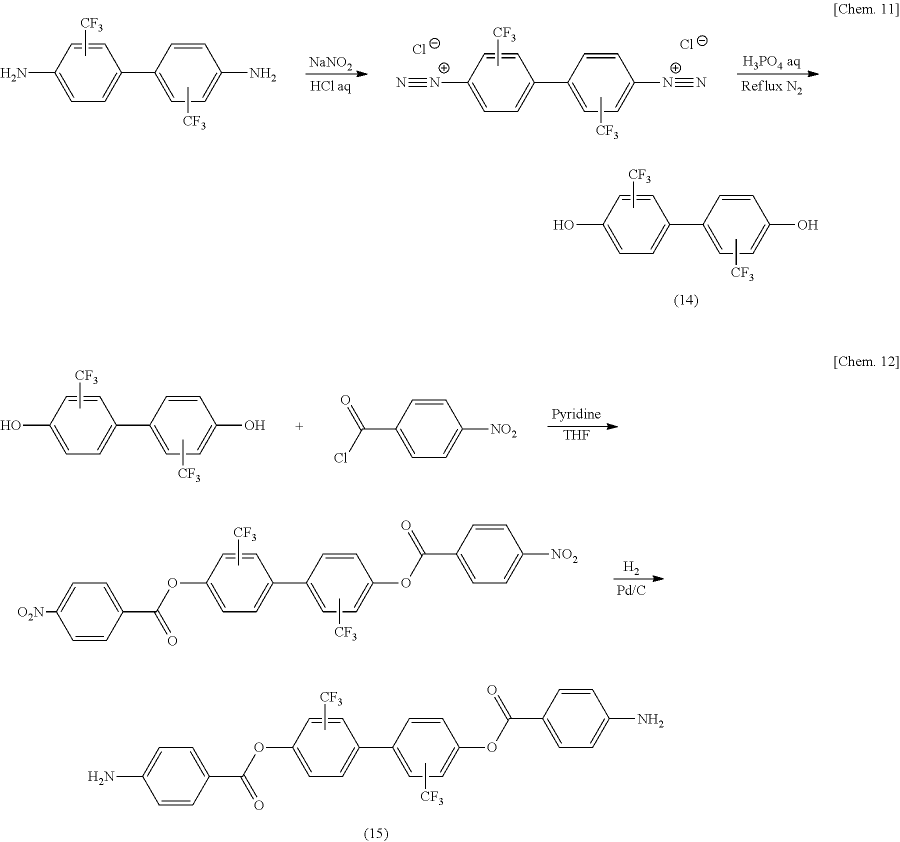

A method of producing the polyimide of the present invention is not particularly limited. The polyimide of the present invention can be produced by use of a given method. The polyimide of the present invention can be produced, for example, by (i) stirring a tetracarboxylic dianhydride and a diamine in an N-methyl-2-pyrrolidone (hereinafter may be called “NMP”) solvent to obtain a polyamic acid which serves as a precursor and (ii) reacting the polyamic acid with acetic anhydride which serves as a dehydration reagent in the presence of a base catalyst (see formula (16) or (17)).

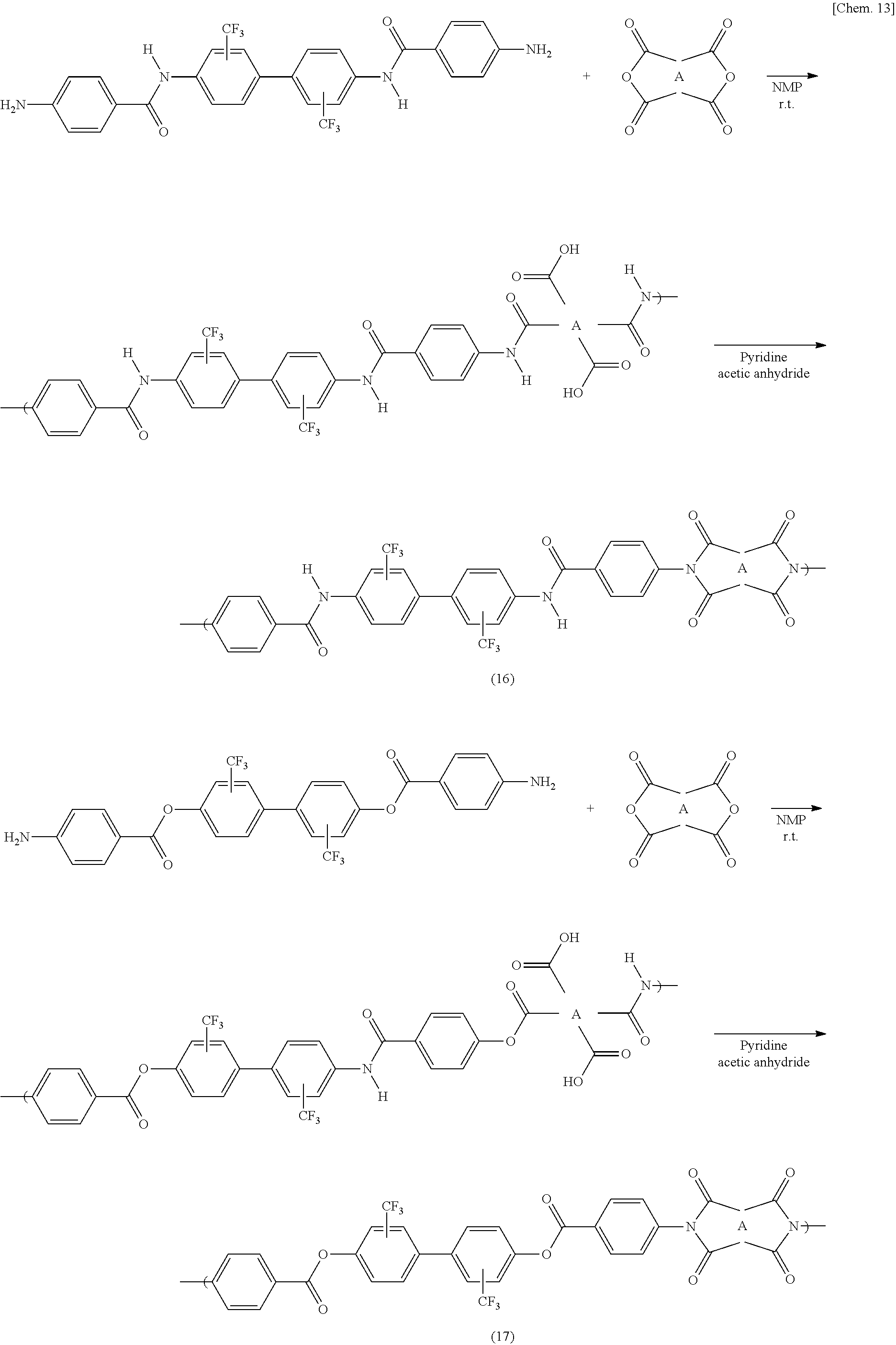

(where A represents a tetravalent aliphatic group)

The polyimide of the present invention can be produced by use of either one of or both of the diamine represented by formula (2) and the diamine represented by formula (9). In a case where the polyimide of the present invention is produced by use of both of the diamines, a molar ratio of the diamines may be determined as appropriate.

The polyimide of the present invention thus produced has a repeating unit represented by formula (3) below.

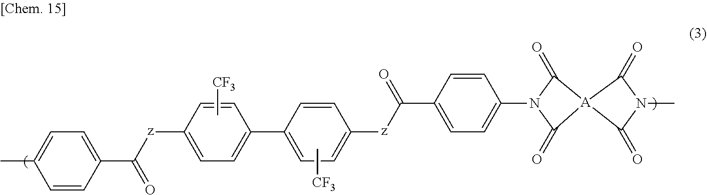

(where A represents a tetravalent aliphatic group, and z represents NH or O)

The polyimide of the present invention thus produced preferably has a repeating unit represented by formula (4) below.

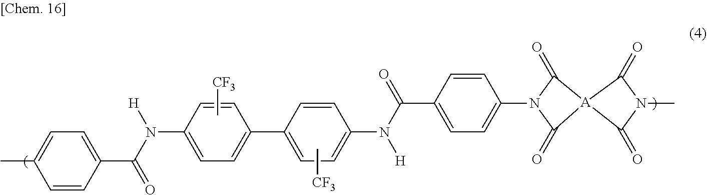

(where A represents a tetravalent aliphatic group)

In order to have a higher transparency, the polyimide of the present invention thus produced preferably has a repeating unit represented by formula (5) below.

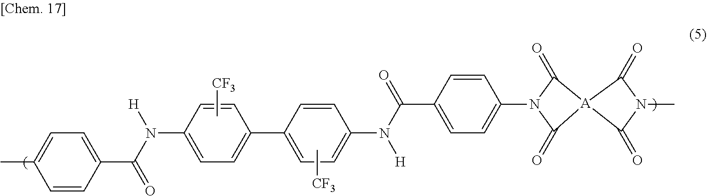

(where A represents a tetravalent aliphatic group)

The polyimide of the present invention thus produced more preferably has a repeating unit represented by formula (6) below.

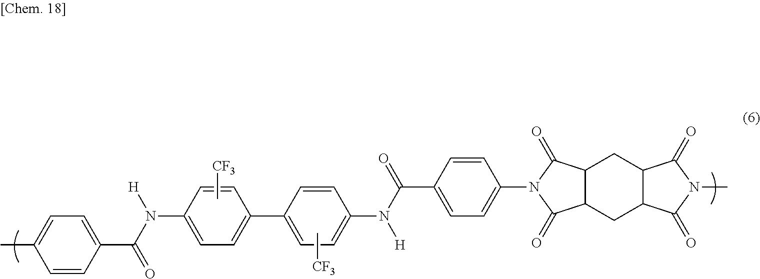

In order to have a higher transparency, the polyimide of the present invention thus produced further preferably has a repeating unit represented by formula (18) below.

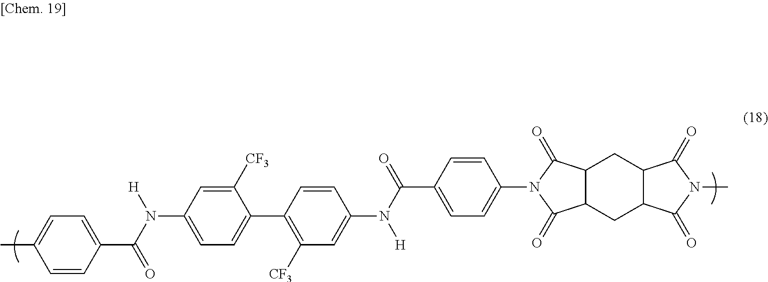

In order to have a lower linear thermal expansion coefficient, the polyimide of the present invention thus produced further preferably has a repeating unit represented by formula (19) below.

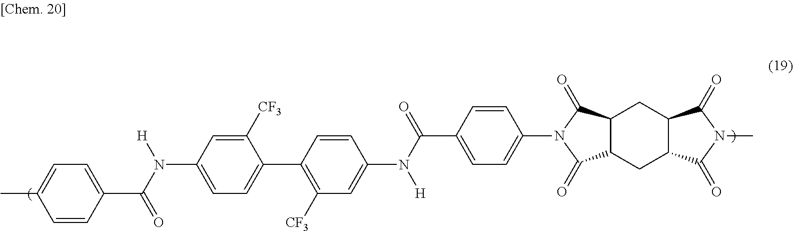

In a case where a first total of all repeating units of the polyimide of the present invention is set to 100 mol %, a second total of the repeating unit represented by at least one of formulas (3) through (6), (18) and (19) accounts for preferably not less than 70 mol % of the first total, more preferably not less than 80 mol % of the first total, further preferably not less than 90 mol % of the first total. In a case where the second total accounts for not less than 70 mol % of the first total, the polyimide of the present invention can have a more excellent solution processability, a higher transparency, a higher heat-resistance, and a lower linear thermal expansion coefficient.

In order to have a higher transparency, the polyimide of the present invention thus produced preferably further has a repeating unit represented by formula (7) below, in addition to the repeating unit represented by at least one of formulas (3) through (6), (18) and (19).

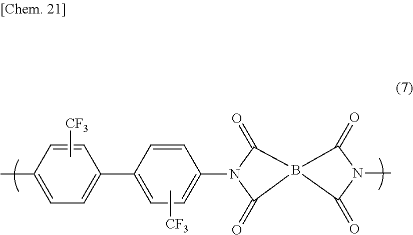

(where B represents a tetravalent aliphatic group)

In the case where the first total of all repeating units of the polyimide of the present invention is set to 100 mol %, a third total of the repeating unit represented by formula (7) accounts for preferably not less than 1 mol % but not more than 50 mol % of the first total, more preferably not less than 10 mol % but not more than 50 mol % of the first total, further preferably not less than 20 mol % but not more than 50 mol % of the first total.

In order to have a lower linear thermal expansion coefficient, the polyimide of the present invention thus produced preferably further has a repeating unit represented by formula (20) below, in addition to the repeating unit represented by at least one of formulas (3) through (6), (18) and (19).

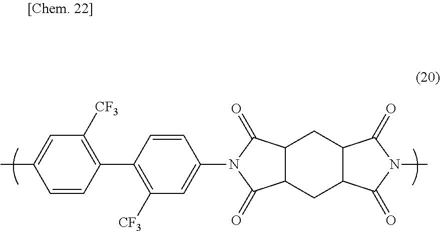

In the case where the first total of all repeating units of the polyimide of the present invention is set to 100 mol %, a fourth total of the repeating unit represented by formula (20) accounts for preferably not less than 1 mol % but not more than 50 mol % of the first total, more preferably not less than 10 mol % but not more than 50 mol % of the first total, further preferably not less than 20 mol % but not more than 50 mol % of the first total.

The polyimide of the present invention can have either one of or both of the repeating unit represented by formula (3) where z represents NH (i.e., the repeating unit represented by formula (4)) and the repeating unit represented by formula (3) where z represents O.

A solvent used in polymerization is not limited provided that (i) a polyamic acid and a polyimide are uniformly dissolved in the solvent and (ii) the solvent does not inhibit any reaction. Examples of the solvent, other than the aforementioned NMP, includes (i) an amide solvent such as N,N-dimethylformamide, N,N-dimethylacetamide, or hexamethylphosphoramide, and (ii) a cyclic ester solvent such as γ-butyrolactone, γ-valerolactone, δ-valerolactone, γ-caprolactone, ε-caprolacton, or α-methyl-γ-butyrolactone. These solvents can be suitably employed.

The polyimide of the present invention can be produced by imidizing a polyamic acid that is obtained by reacting a tetracarboxylic dianhydride and a diamine with each other. How to imidize a polyamic acid is not particularly limited. The polyamic acid can be imidized by use of a publicly-known method (a chemically imidizing method or a thermally imidizing method).

A method of producing a polyimide by use of the chemically imidizing method will be described below. A chemically imidizing reagent containing an organic acid anhydride and a tertiary amine that serves as a catalyst is dropped into (i) a polyimide precursor varnish obtained as a result of a polymerization or (ii) a polyimide precursor varnish which is moderately diluted with a solvent identical to the solvent used in polymerization, while the polyimide precursor varnish is being stirred. A mixture of the polyimide precursor varnish and the chemically imidizing reagent is stirred for 0.5 to 48 hour(s) at 0° C. to 10° C., preferably at 20° C. to 50° C. This easily completes an imidization reaction.

The organic acid anhydride which can be used in the chemically imidizing method is not particularly limited. Examples of the organic acid anhydride include acetic anhydride, propionic anhydride, maleic anhydride, and phthalic anhydride. Among these organic acid anhydrides, acetic anhydride is suitably employed from the viewpoint of a cost and an easy post-treatment (easy removal). The tertiary amine which can be used in the chemically imidizing method is neither particularly limited. Examples of the tertiary amine include pyridine, triethylamine, and N,N-dimethylaniline. Among these tertiary amines, pyridine is suitably employed from the viewpoint of safety.

An amount of the organic acid anhydride to be contained in the chemically imidizing reagent is not particularly limited. However, the amount of the organic acid anhydride falls within a range from 1 to 10 time(s) by mol of a theoretical dehydration amount of a polyimide precursor, preferably a range from 2 to 5 times by mol of the theoreical dehydration amount from the viewpoint of completion of a reaction, a reaction rate, and a post-treatment. An amount of the tertiary amine to be used is not particularly limited. However, from the viewpoint of completion of a reaction, a reaction rate, and a post-treatment (easy removal), the amount of the tertiary amine to be used preferably falls within a range from 0.1 to 1 time by mol of the amount of the organic acid anhydride.

The polyimide of the present invention can also be produced by use of the thermally imidizing method (by means of thermal imidization). The thermally imidizing method is performed, for example, (i) by heating a polyamic acid solution or (ii) spreading or applying a polyamic acid solution over/to a glass plate, a metal plate, or a support of PET (polyethylene terephthalate) etc., and then heating the polyamic acid solution at 80° C. to 500° C. Alternatively, a polyamic acid solution is directly put into a container to which a mold-release treatment such as coating with fluororesin has been subjected, and is then thermally dried under reduced pressure. This causes cyclodehydration of a polyamic acid of the polyamic acid solution. Thanks to such cyclodehydration of the polyamic acid by use of the thermally imidizing method, a polyimide resin can be obtained. Note that a heating time in each of the above treatments varies depending on (i) an amount of a polyamic acid solution to be cyclodehydrated and (ii) a heating temperature at which the polyamic acid solution is heated. Generally, it is preferable that the heating time falls within a range from 1 minute to 5 hours after the heating temperature reaches a maximum temperature.

Alternatively, the polyimide of the present invention can be produced by use of an azeotropic method in which an azeotropic solvent is used. In this case, a solvent, such as toluene or xylene, which is azeotropic with water is added to a polyamic acid solution. A mixture of the solvent and the polyamic acid solution is heated to 170° C. to 200° C., and reacted for approximately 1 to 5 hour(s) while water generated due to cyclodehydration is frequently removed outside of a system. After the reaction, the mixture is precipitated in a poor solvent such as an alcoholic solvent. If necessary, the precipitate is washed with alcohol etc., and then dried. This makes it possible to obtain a polyimide resin.

An obtained imidized reaction solution is dropped into a large amount of poor solvent, so that a polyimide is precipitated. The polyimide is repetitively washed so that a reaction solvent, a chemically imidizing agent, a catalyst, etc., are removed and is then dried under reduced pressure. This makes it possible to obtain polyimide powder. The poor solvent which can be used is not particularly limited provided that the poor solvent does not dissolve the polyimide. However, from the viewpoint of (i) affinity with a reaction solvent or a chemically imidizing agent and (ii) an easy removal by drying, a solvent such as water, methanol, ethanol, n-propanol, isopropanol, or a mixture thereof is suitably employed as the poor solvent.

A solid content concentration of a polyimide solution to be dropped into a poor solvent, the polyimide solution containing a polyimide, an imidization accelerator, and a dehydration agent, is not particularly limited provided that the polyimide solution has a viscosity at which the polyimide solution is stirrable in the poor solvent. However, from the viewpoint of reduction in particle diameter, the solid content concentration is preferably low. On the other hand, a very low solid content concentration is not suitable because it is necessary to use a large amount of poor solvent to precipitate a polyimide. In terms of this, it is preferable to drop, into a poor solvent, a polyimide solution which has been diluted so as to have a solid content concentration of not more than 15%, preferably not more than 10%. An amount of the poor solvent to be used is preferably equal to or larger than an amount of the polyimide solution, more preferably twice to three times as large as that of the polyimide solution. An obtained polyimide contains a small amount of imidization accelerator and dehydration agent. It is therefore preferable to wash the obtained polyimide with the above-described poor solvent several times.

The polyimide thus produced by the chemically imidizing method or the thermally imidizing method can be dried by means of vacuum drying or hot-air drying. In order to completely dry a solvent contained in a resin, the polyimide is preferably dried by means of the vacuum drying. A drying temperature preferably falls within a range from 80° C. to 200° C., from the viewpoint of (i) decomposition of a residual solvent and (ii) prevention of deterioration in quality of the resin due to the residual solvent. A drying time is not particularly limited provided that the solvent contained in the resin is completely dried off. However, from the viewpoint of a production process cost, the drying time is preferably not less than 8 hours, and from the viewpoint of sufficient drying of the residual solvent, the drying time is preferably not more than 15 hours.

A weight-average molecular weight of the polyimide of the present invention falls within preferably a range from 5,000 to 500,000, more preferably a range from 10,000 to 300,000, further preferably a range from 30,000 to 200,000, though the weight-average molecular weight differs depending on the purpose of use of the polyimide of the present invention. A coating film of or a film of the polyimide of the present invention having a weight-average molecular weight of not less than 5,000 can have a further sufficient strength. A coating film of or a film of the polyimide of the present invention having a weight-average molecular weight of not more than 500,000 can have a flat surface and an uniform thickness, because the polyimide of the present invention having the weight-average molecular weight of not more than 500,000 does not increase its viscosity so much and can keep a satisfactory dissolvability. What is meant by “molecular weight” here is a value measured based on polyethylene glycol by means of Gel Permeation Chromatography (GPC). In a case where a polyimide is not soluble in a solvent for use in measurement by means of GPC, a molecular weight of a polyamic acid that is a precursor of the polyimide can be employed instead of a molecular weight of the polyimide itself.

A film of the polyimide of the present invention can be produced by use of a given method. Examples of a method of producing a film of the polyimide of the present invention include a method of dissolving a polyimide in a given organic solvent to obtain a mixed solution, applying the mixed solution to a base material, and then drying the liquid solution. The organic solvent to be used is not particularly limited. Examples of the organic solvent include: an amide solvent such as dimethylformamide (DMF), dimethylacetamide (DMAc), or N-methyl-2-pyrrolidone (NMP); a ketone solvent such as acetone, methyl ethyl ketone (MEK), methyl isobutyl ketone (MIBK), cyclopentanone, or cyclohexanone; an ether solvent such as tetrahydrofuran (THF), 1,3-dioxolane, or 1,4-dioxane; an ester solvent such as methyl acetate, ethyl acetate, butyl acetate, γ-butyrolactone, α-acetolactone, β-propiolactone, or δ-valerolactone; symmetric glycol diethers such as methyl monoglyme (1,2-dimethoxyethane), methyl diglyme (bis(2-methoxyethyl)ether), methyl triglyme (1,2-bis(2-methoxyethoxy)ethane), methyl tetraglyme (bis[2-(2-methoxyethoxyethyl)]ether), ethyl monoglyme (1,2-diethoxyethane), ethyl diglylme (bis(2-ethoxyethyl)ether), and butyl diglyme (bis(2-butoxyethyl)ether); ethers such as dipropylene glycol methyl ether, tripropylene glycol methyl ether, propylene glycol n-propyl ether, dipropylene glycol n-propyl ether, propylene glycol n-butyl ether, dipropylene glycol n-butyl ether, tripropylene glycol n-propyl ether, propylene glycol phenyl ether, dipropylene glycol dimethyl ether, 1,3-dioxolane, ethylene glycol monobutyl ether, diethylene glycol monoethyl ether, diethylene glycol monobutyl ether, and ethylene glycol monoethyl ether. It is preferable to use at least one organic solvent selected from these organic solvents. It is particularly preferable that the polyimide of the present invention dissolves in all of the amide solvent, the ketone solvent, and the ether solvent. This is because it is possible to select as appropriate one(s) of these solvents in accordance with a substrate to which the selected solvent(s) is/are to be applied. In order to prevent problems such as whitening, non-uniformity, and hardening of a coating film due to moisture absorption of the coating film which is being dried during application of the coating film, it is preferable to use in combination the amide solvent, and the ketone solvent or the ether solvent, and it is further preferable to use solely the ketone solvent or the ether solvent, or use in combination the ketone solvent and the ether solvent. Examples of a particularly preferable amide solvent include a dimethylformamide (DMF), a dimethylacetamide (DMAc), and an N-methyl-2-pyrrolidone (NMP). Examples of a particularly preferable ketone solvent include a methyl ethyl ketone (MEK), a methyl isobutyl ketone (MIBK), a cyclopentanone, and a cyclohexanone. Examples of a particularly preferable ether solvent include a methyl monoglyme (1,2-dimethoxyethane), a methyl diglyme (bis(2-methoxyethyl)ether), and a methyl triglyme (1,2-bis(2-methoxyethoxy)ethane). A concentration of a polyimide solution of the present invention preferably falls within a range from 5% by weight to 40% by weight. In order to keep a coating film flat, the concentration further preferably falls within a range from 5% by weight to 20% by weight.

A viscosity of the polyimide solution is determined as appropriate according to a thickness of a coating film and an application environment. The viscosity falls within preferably a range from 0.1 Pa·s to 50 Pa·s, further preferably a range from 0.5 Pa·s to 30 Pa·s. A polyimide solution having a viscosity of not less than 0.1 Pa·s can keep a sufficient solution viscosity. This makes it possible to keep a sufficient precision of a film thickness. A polyimide solution having a viscosity of not more than 50 Pa·s allows not only keeping an accuracy of a film thickness but also much surely preventing occurrence of a defect of an external appearance such as a defect of gel which is caused by drying of a coating film immediately after application. The viscosity is a kinematic viscosity which is measured at 23° C. by use of an E-type viscometer.

A polyimide film of the present invention can be produced by applying a polyimide solution to a support, and drying the polyimide solution. The polyimide film can also be produced by (i) applying, to a support, a polyamic acid that is a polyimide precursor to form a film of the polyamic acid, and (ii) heating the film to imidize and dry the film. From the viewpoint of a thermal expansion characteristic of and a dimensional stability of a produced polyimide film, it is more preferable to produce the polyimide film of the present invention by applying a polyimide solution to a support, and drying the polyimide solution.

Examples of a substrate to which the polyimide solution is to be applied include a glass substrate, a metal substrate or belt of SUS (stainless steel) etc., and a plastic film of, for example, polyethylene terephthalate, polycarbonate, polyacrylate, polyethylene naphthalate, or triacetyl cellulose. However, the substrate is not limited to these examples. Among these examples, the glass substrate is preferably employed so as to be suitable for an existing batch-type device production process.

A drying temperature during production of a polyimide film can be determined in accordance with a process. The drying temperature is not particularly limited provided that the drying temperature does not affect a characteristic of the polyimide film.

The polyimide of the present invention as it is can be subjected to a coating process or a shaping process for producing a product or a member. Alternatively, the polyimide of the present invention can be employed as a lamination obtained by subjecting a film of the polyimide of the present invention to a process such as a coating process. In order to be subjected to the coating process or the shaping process, a polyimide resin composition may be prepared. The polyimide resin composition can be prepared by dissolving or dispersing the polyimide of the present invention in a solvent if necessary, and further mixing with a photo- or heat-curable component, a non-polymerizable binder resin other than the polyimide of the present invention, and other component(s).

A polyimide resin composition of the present invention can be mixed with various organic or inorganic low-molecular or high-molecular compounds so as to have a processing characteristic and/or various functional characteristics. Examples of these compounds include dye, a surfactant, a leveling agent, a plasticizer, fine particles, and a sensitizer. Examples of the fine particles include (i) organic fine particles of, for example, polystyrene or polytetrafluoroethylene, and (ii) inorganic fine particles of, for example, colloidal silica, carbon, or sheet silicate. These fine particles can be porous or hollow. The low-molecular or high-molecular compounds serve as, for example, a pigment or a filler. Examples of a form of the low-molecular or high-molecular compounds include fiber.

The polyimide film of the present invention can have a surface on which various inorganic thin films of, for example, a metal oxide and a transparent electrode are formed. A method of forming these inorganic thin films is not particularly limited. Examples of the method include a CVD method, and a PVD method such as a sputtering method, a vacuum vapor deposition method, or an ion plating method.

The polyimide film of the present invention has a high dimensional stability and a high dissolvability in an organic solvent, in addition to original characteristics of polyimide such as heat resistance and an insulating property. It is therefore preferable that the polyimide film of the present invention is used in a field or a product where these characteristics of the polyimide film of the present invention are effective. Examples of the product include a substrate, a color filter, a printed material, an optical material, an electronic device, and an image display device. It is further preferable that the polyimide film of the present invention is employed as an alternative material for a part made of a glass or transparent material. Examples of the substrate include a TFT substrate, a flexible display substrate, and a transparent electrically-conductive film substrate. Examples of the electronic device include a touch panel and a solar battery. Examples of the image display device include a flexible display, a liquid crystal display device, an organic EL, an electronic paper, and a three-dimensional display. Examples of the optical material include an optical film.

The present invention can be further configured as below.

3. The diamine described in 1 above, wherein the diamine is represented by formula (2).

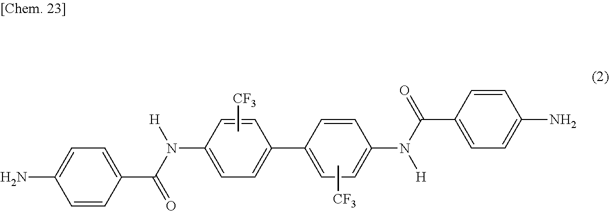

4. The polyimide described in 2 above, wherein the polyimide has a repeating unit represented by formula (4)

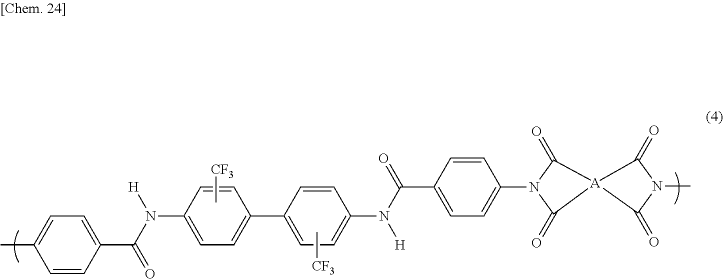

where A represents a tetravalent aliphatic group.

5. The polyimide described in 2 or 4 above, wherein the polyimide has a repeating unit represented by formula (5)

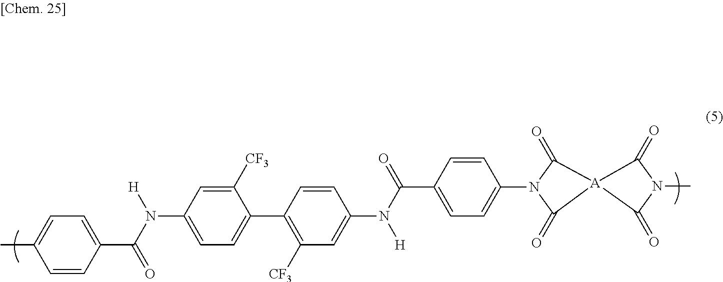

where A represents a tetravalent aliphatic group.

6. The polyimide described in 2 or 4 above, wherein the polyimide has a repeating unit represented by formula (6).

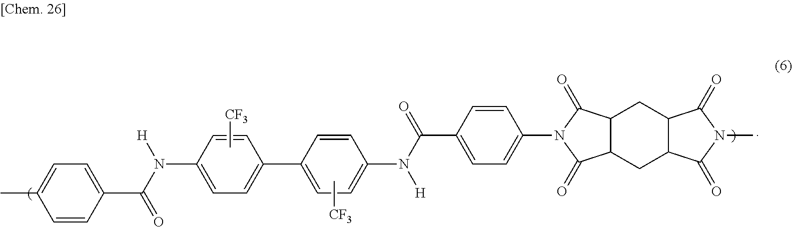

7. The polyimide described in any one of 2, and 4 through 6 above, wherein the polyimide further has a repeating unit represented by formula (7)

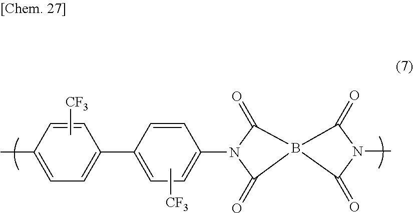

where B represents a tetravalent aliphatic group.

8. A polyimide film of a polyimide described in any one of 2, and 4 through 7 above.

9. A substrate including a polyimide film described in 8 above.

10. A color filter including a polyimide film described in 8 above.

11. An image display device including a polyimide film described in 8 above.

12. An optical material including a polyimide film described in 8 above.

13. An electronic device including a polyimide film described in 8 above.

### EXAMPLES

The following description will discuss Examples so as to more specifically explain the present invention. However, the present invention is not limited to these Examples. Note that physical values in the Examples were measured by use of the following methods.

(Measurement of Average Linear Thermal Expansion Coefficient)

An average linear thermal expansion coefficient (which can be hereinafter referred to as “CTE”) of a sample (sample size: 5 mm in width; and 20 mm in length), which fell within a range from 100 to 200, was measured by use of a thermomechanical analyzer TMA4000 (measuring jig intervals: 15 mm) manufactured by Bruker AXS K.K. while a load of a film thickness (μm)×0.5 g was being applied to the sample. In a dry nitrogen atmosphere, a temperature of the sample was increased by 5° C. per minute up to 150° C. (first temperature increase), then decreased to 20° C., and increased again by 5° C. per minute (second temperature increase). The average linear thermal expansion coefficient was calculated based on a TMA curve obtained during the second temperature increase.

(Measurement of Glass Transition Temperature)

A dynamic viscoelasticity of a sample was measured by use of a thermomechanical analyzer TMA4000 manufactured by Bruker AXS K.K. while (i) a measurement length (measuring jig intervals) was set to 15 mm and (ii) a load which changes sinusoidally (amplitude: 15 g) was being applied to the sample. A temperature of the sample, at which energy loss was maximized, was considered to be a glass transition temperature (Tg) of the sample.

(Measurement of Thermal Decomposition Temperature)

Approximately 5 mg to 10 mg of a sample was precisely scaled by use of a thermogravimetric analyzer TG-DTA2000 (manufactured by Bruker AXS K.K.), and was put in one aluminum pan. The other aluminum pan was empty. A weight value was set to zero. Then, a temperature of the sample in the aluminum pan was increased by 10° C. per minute up to 550° C. in a nitrogen atmosphere. A temperature of the sample, at which the sample was decreased by 5% by weight, was measured as a thermal decomposition temperature (Td5) of the sample.

(Measurement of Mechanical Characteristic)

A polyimide film of 3 mm×35 mm was fixed to a jig, and positioned on a tension testing machine (a universal testing machine TENSILON UTM-2 (manufactured by A&D Company, Limited)) while intervals between chucks were set to 20 mm. The polyimide film was subjected to a tension test at a crosshead speed of 8 mm per minute. In the tension test, an average elongation, a maximum elongation, a modulus of elasticity in tension, and a breaking strength of the polyimide film were measured by use of the tension testing machine.

(Measurement of Light Transmittance)

A first light transmittance (T %) of a polyimide film was measured at a wavelength which fell within a range from 200 nm to 800 nm by use of a V-530 UV-Vis Spectrophotometer (manufactured by JASCO Corporation). A wavelength at which the first light transmittance reached not more than 0.5% was considered to be a cutoff wavelength. The cutoff wavelength served as a first indicator of a transparency of the polyimide film. A second light transmittance of the polyimide film was measured at a wavelength of 400 nm. The second light transmittance served as a second indicator of the transparency of the polyimide film. The transparency of the polyimide film was evaluated.

(Measurement of Refractive Index)

A refractive index was measured by use of an Abbe Refractometer 4T (manufactured by ATAGO CO., LTD.). In this measurement, a Na D line (589.3 nm) was employed as a light source, a methylene iodine solution which was saturated with sulfur (n^{D}=1.72 to 1.80) was employed as an intermediate solution, and a test piece (n^{D}=1.72) was used.

(Measurement of Intrinsic Viscosity)

Intrinsic viscosities of (i) 0.5 wt % of a polyimide solution and (ii) 0.5 wt % of a polyamic acid solution were measured at 30° C. by use of an Ostwald viscometer No. 2 (manufactured by SIBATA SCIENTIFIC TECHNOLOGY LTD.). NMP was employed as a solvent of these solutions in Examples 1 and 2. DMAc was employed as the solvent in Comparative Examples 1 through 5.

(Evaluation of Solution Processability)

Polyimide powder was added into a solvent which was 99 times as heavy as the polyimide powder. A mixture of the polyimide powder and the solvent was stirred for five minutes by use of a test tube mixer. After the stirring, a dissolution state of the mixture was visually checked. As the solvent were used chloroform, acetone, THF, 1,4-dioxane, ethyl acetate, cyclopentanone, cyclohexanone, DMAc, N-methyl-2-pyrrolidone, dimethyl sulfoxide, and γ-butyrolactone. Evaluation was as given below: “++” represents a case where the polyimide powder was dissolved at room temperature; “+” represents a case where the polyimide powder was thermally dissolved, and still uniformly dissolved even after being left as it was to be cooled to room temperature; “±” represents a case where the polyimide powder was swollen or partially dissolved; and “−” represents a case where the polyimide powder was not dissolved. Note that, (i) in a case where chloroform, acetone, THF, or ethyl acetate was employed as the solvent, a heat temperature at which the mixture was heated was set to 50° C., (ii) in a case where 1,4-dioxane, cyclopentanone, or cyclohexanone was employed as the solvent, the heat temperature was set to 100° C., and (iii) in a case where DMAc, N-methyl-2-pyrrolidone, dimethyl sulfoxide, or γ-butyrolactone was employed as the solvent, the heat temperature was set to 150° C.

(Abbreviated Name of Used Material)

Compound names can be abbreviated as follows:

Tetrahydrofuran=THF;

2,2′-bis(trifluoromethyl)benzidine=TFMB;

(1S,2S,4R,5R)-cyclohexanetetracarboxylic dianhydride=H′-PMDA;

N,N-dimethylacetamide=DMAc; and

4,4′-diaminobenzanilide=DABA.

### Example 1

### Synthesis of Diamine

The diamine (hereinafter referred to as “ABMB”) represented by formula (8) was synthesized by use of the method represented by formula (13). How to synthesize the diamine will be described in detail below.

<Synthesis of ABMB Precursor (NBMB)>

First, 3.2023 g (10 mmol) of 2,2′-bis(trifluoromethyl)benzidine (TFMB), 1.75 mL of THF, and 3.3 mL (40 mmol) of a pyridine solution were added, by use of a syringe, to a liquid solution in an ice bath in which liquid solution 3.8023 g (20.5 mmol) of 4-nitrobenzene carboxylic acid chloride (4-NBC) was dissolved in 6.26 mL of tetrahydrofuran (hereinafter referred to as “THF”). This generated a large amount of yellowish-white precipitate. The large amount of yellowish-white precipitate was left for 12 hours, filtered, and sufficiently washed with THF and then ion exchange water. Obtained powder was dried at 100° C. for 12 hours under reduced pressure. Consequently, 5.9216 g of a nitro compound (hereinafter referred to as “NBMB”, yield: 95.7%) that was an ABMB precursor was obtained. The NBMB was identified by proton NMR and FT-IR.

<Synthesis of ABMB>

First, 9.2410 g (14.94 mmol) of NBMB, and 0.9279 g of Pd/C were dissolved and dispersed in 120 mL of ethanol. An obtained liquid solution was bubbled with hydrogen gas at 80° C. so as to be reacted for 7 hours. A reaction end point was determined by means of thin layer chromatography. After completion of the reaction, a reaction mixture was thermally filtered, and then an obtained filtrate was dropped into water. This generated white precipitate. The white precipitate was stirred in the water for 12 hours. After the stirring, obtained powder was removed, sufficiently washed with water, and then dried at 100° C. for 12 hours under reduced pressure. Consequently, 7.9811 g of an ABMB crude product (yield: 95.6%) was obtained.

The ABMB crude product was purified as below. In the presence of 0.5 g of activated carbon, 0.5012 g of the ABMB crude product was dissolved at 65° C. in 40 mL of ethanol and 10 mL of ion exchange water. An obtained liquid solution was thermally filtered. To an obtained filtrate was added 20 mL of ion exchange water. A mixture of the filtrate and the ion exchange water was cooled. Consequently, 0.4212 g of a purified ABMB product (recrystallization yield: 84.0%) was obtained.

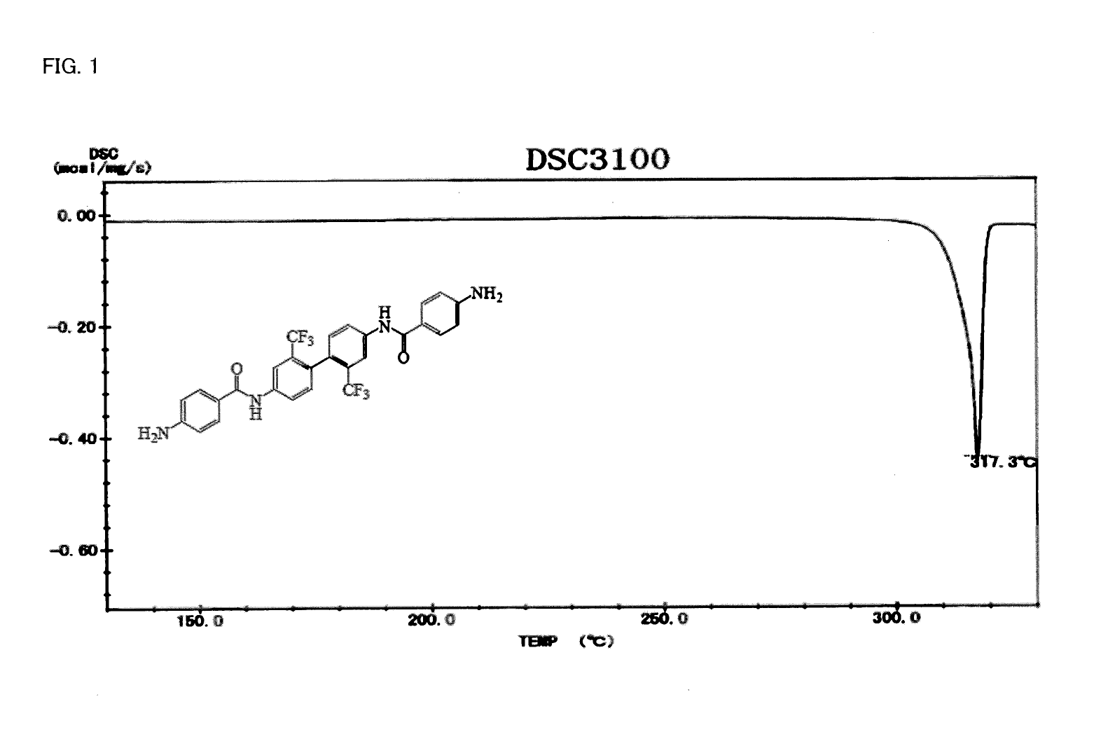

A melting point of the ABMB product was measured by use of a differential scanning calorimeter DSC3100 (manufactured by Bruker AXS K.K.), so that a steep heat-absorption peak was found at 317° C. (see FIG. 1). It was found that the ABMB product was a high-purity product.

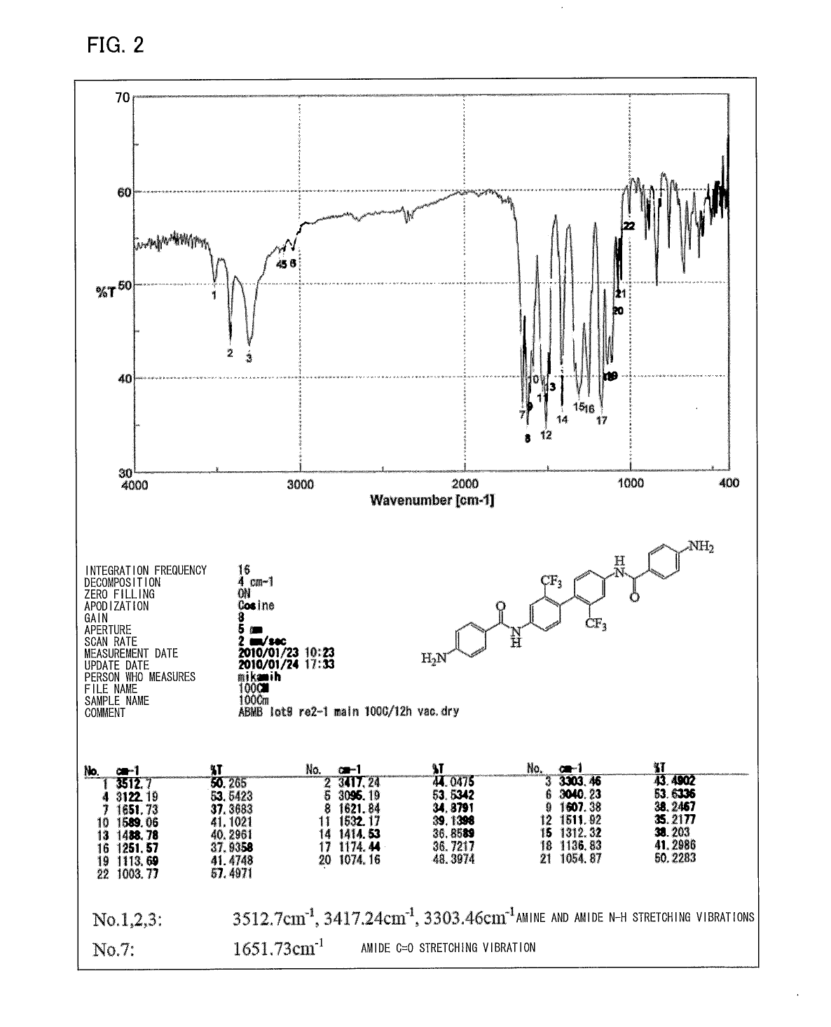

A KBr tablet method was performed with respect to the ABMB product by use of a Fourier transform infrared spectrophotometer FT/IR5300 (manufactured by JASCO Corporation), so that amine and N—H stretching vibrations were found at 3512 cm⁻¹, 3417 cm⁻¹, and 3303 cm⁻¹, and amide C═O stretching vibration was found at 1651 cm⁻¹ (see FIG. 2).

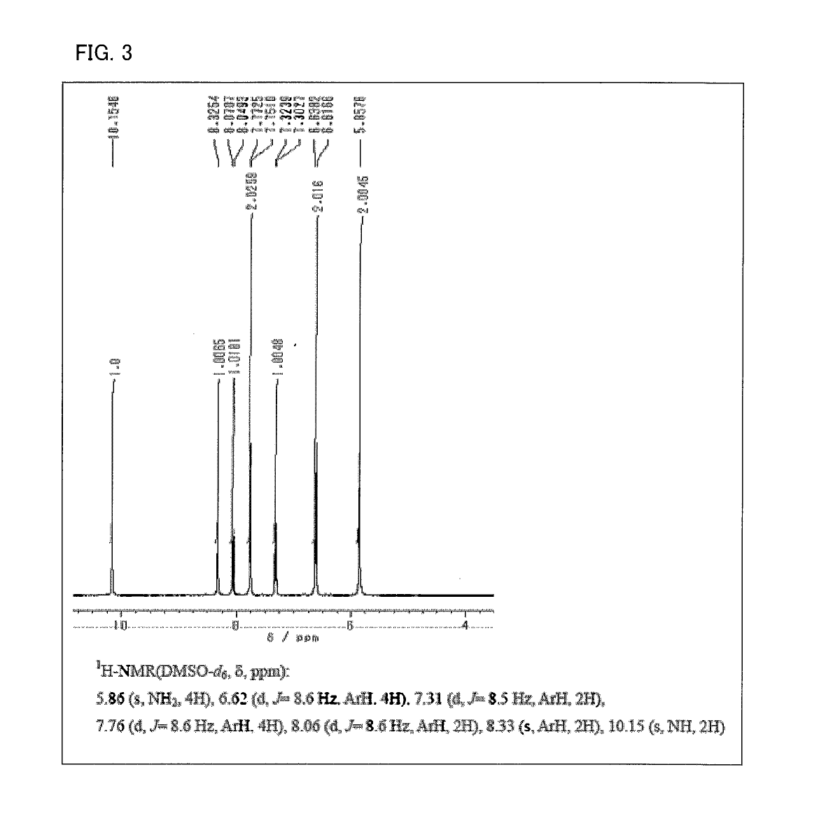

The ABMB product was subjected to proton NMR measurement by use of a Fourier transform nuclear magnetic resonance JNM-ECP400 (manufactured by JEOL Ltd.). Assignment results were as follows: (400 MHz, DMSO-d₆, δ, ppm): 5.86 (s, NH₂, 4H), 6.62 (d, J=8.6 Hz, ArH, 4H), 7.31 (d, J=8.5 Hz, ArH, 2H), 7.76 (d, J=8.6 Hz, ArH, 4H), 8.06 (d, J=8.6 Hz, ArH, 2H), 8.33 (s, ArH, 2H), 10.15 (s, NH, 2H) (see FIG. 3). It was found that the ABMB product was a target product.

### Example 2

First, 1.6754 g (3 mmol) of ABMB was dissolved in 5.4784 g of NMP. To an obtained liquid solution was added 0.6725 g (3 mmol) of H′-PMDA. The liquid solution was stirred for 7 hours at room temperature, and then diluted with NMP so that a diluted solution had a solid content concentration of 10.2 wt %. Subsequently, a mixed solvent of 3.0627 g (30 mmol) of acetic anhydride and 1.1865 g (15 mmol) of pyridine was slowly dropped into the diluted solution at room temperature. An obtained mixed solution of the mixed solvent and the diluted solution was stirred for 24 hours. A large amount of methanol was added to the mixed solution. This generated target white precipitate. The white precipitate was sufficiently washed with methanol, and then dried in vacuum.

Obtained polyimide powder was dissolved in cyclopentanone so that a 3 wt % liquid solution was prepared. The liquid solution was spread over a glass substrate, and dried at 60° C. for two hours by use of a hot-air drier. The liquid solution thus dried was separated from the glass substrate, and further dried in vacuum at 250° C. for 1 hour. Consequently, a polyimide film (hereinafter referred to as “film”) was produced. Specifically, two kinds of film, i.e., a first film whose thickness was 10 μm and a second film whose thickness was 15 μm were produced. The first film was used to measure an average linear thermal expansion coefficient, a glass transition temperature, and a mechanical characteristic of the first film. The second film was used to measure a light transmittance and a refractive index of the second film.

The mechanical characteristic of the first film was measured. It was found that the first film had an average elongation of 12%, a maximum elongation of 31%, a modulus of elasticity in tension of 3.4 GPa, and a breaking strength of 0.12 GPa (each of these values is an average of measured 20 first films each 10 μm in thickness).

### Example 3

Example 3 was identical to Example 2 except that, in Example 3, a film production condition was changed as below. Obtained polyimide powder was dissolved in cyclopentanone so that a 3 wt % liquid solution was prepared. The liquid solution was spread over a glass substrate, dried at 60° C. for two hours by use of a hot-air drier, further dried in vacuum at 250° C. for 1 hour on the glass substrate, separated from the glass substrate, and then further thermally processed in vacuum at 250° C. for 1 hour. Consequently, a film was produced. Specifically, two kinds of film, i.e., a first film whose thickness was 10 μm and a second film whose thickness was 15 μm were produced. The first film was used to measure an average linear thermal expansion coefficient and a mechanical characteristic of the first film. The second film was used to measure a refractive index of the second film.

The mechanical characteristic of the first film was measured. It was found that the first film had an average elongation of 12%, a maximum elongation of 31%, a modulus of elasticity in tension of 3.4 GPa, and a breaking strength of 0.12 GPa (each of these values is an average of measured 20 first films each 10 μm in thickness).

### Example 4

First, 1.3403 g (2.4 mmol) of ABMB and 0.1921 g (0.6 mmol) of TFMB were dissolved in 5.1448 g of NMP. To an obtained liquid solution was added 0.6725 g (3 mmol) of H′-PMDA. The liquid solution was stirred for 7 hours at room temperature, and then diluted with NMP so that a diluted solution had a solid content concentration of 10.0 wt %. Subsequently, a mixed solvent of 3.0627 g (30 mmol) of acetic anhydride and 1.1865 g (15 mmol) of pyridine was slowly dropped into the diluted solution at room temperature. An obtained mixed solution of the mixed solvent and the diluted solution was stirred for 24 hours. A large amount of methanol was added to the mixed solution. This generated target white precipitate. The white precipitate was sufficiently washed with methanol, and then dried in vacuum. Note that an obtained polyimide had the repeating unit represented by formula (15) in 20 mol %.

Obtained polyimide powder was dissolved in cyclopentanone so that a 18 wt % liquid solution was prepared. The liquid solution was spread over a glass substrate, dried at 60° C. for two hours by use of a hot-air drier, further dried in vacuum at 250° C. for 1 hour on the glass substrate, separated from the glass substrate, and then further thermally processed in vacuum at 250° C. for 1 hour. Consequently, a film was produced. Specifically, two kinds of film, i.e., a first film whose thickness was 20 μm and a second film whose thickness was 28 μm were produced. The first film was used to measure an average linear thermal expansion coefficient and a mechanical characteristic of the first film. The second film was used to measure a light transmittance of the second film.

The mechanical characteristic of the first film was measured. It was found that the first film had an average elongation of 22%, a maximum elongation of 31%, a modulus of elasticity in tension of 4.5 GPa, and a breaking strength of 0.15 GPa (each of these values is an average of measured 20 first films each 28 μm in thickness).

### Example 5

### Synthesis of Diamine

The diamine (hereinafter referred to as “EBMB”) represented by formula (10) was synthesized by use of the method represented by formula (14) and the method represented by formula (15). How to synthesize the diamine will be described in detail below.

### Synthesis of intermediate 2,2′-bis(trifluoromethyl)-4,4′-dihydroxybiphenyl (TFBD)

An intermediate TFBD was synthesized by use of the method represented by formula (14). First, in a nitrogen atmosphere, 24 mL of concentrated hydrochloric acid and 100 mL of water were put into a three-neck flask, and then 3.0128 g (9.99 mmol) of TFMB was added into this aqueous solution. An obtained mixed solution of the concentrated hydrochloric acid, the water, and the TFMB was stirred. An aqueous solution in which 1.3802 g (30 mmol) of sodium nitrite was dissolved in 8 mL of water was dropped, by use of a syringe, to the mixed solution whose temperature was set to minus 4° C. After the dropping, the mixed solution was stirred for 2 hours while being kept at minus 4° C. After the stirring, 0.1009 g (10 mmol) of urea was added to the mixed solution. The mixed solution was further stirred for 30 minutes. In this way, a liquid solution A was prepared.

On the other hand, 7 mL of phosphoric acid and 500 mL of water were put into another three-neck flask in a nitrogen atmosphere. This prepared a liquid solution B. The liquid solution A was dropped little by little into the liquid solution B whose temperature was kept at 90° C. After the dropping, a resultant mixture of the liquid solution A and the liquid solution B was refluxed for 1 hour, stirred for 1 day at room temperature, and then extracted with diethyl ether. Thereafter, a solvent was distilled off. Consequently, 1.5104 g of target whitish-yellow powder was obtained (yield: 46.9%).

A melting point of the whitish-yellow powder was measured by use of the differential scanning calorimeter DSC3100 (manufactured by Bruker AXS K.K.), so that a steep heat-absorption peak was found at 148° C. It was found that the whitish-yellow powder was a high-purity product. The whitish-yellow powder was identified by proton NMR and FT-IR.

<Synthesis of EBMB Precursor (EBNB)>

First, 1.4002 g (4.35 mmol) of TFBD, 7.4 mL of THF, and 1.4 mL (17.4 mmol) of a pyridine solution were added, by use of a syringe, to a liquid solution in an ice bath in which liquid solution 4-nitrobenzene carboxylic acid chloride (4-NBC) was dissolved in 2.8 mL of THF. This generated yellowish-white precipitate. After 12 hours, the yellowish-white precipitate was precipitated again in a large amount of water, and stirred in the water for 1 day. After the stirring, the yellowish-white precipitate was filtered, washed, and then further filtered to be collected. Obtained powder was dried at 100° C. for 12 hours under reduced pressure. Consequently, 2.1672 g of a nitro compound (hereinafter referred to as “EBNB”, yield: 80.3%), which was an EBMB precursor, was obtained.

A melting point of the EBNB was measured by use of the differential scanning calorimeter DSC3100 (manufactured by Bruker AXS K.K.), so that a steep heat-absorption peak was found at 237° C. It was found that the nitro compound was a high-purity product. The EBNB was identified by proton NMR and FT-IR.

<Synthesis of EBMB>

First, 4.0041 g (6.4539 mmol) of EBNB and 0.4295 g of Pd/C were dissolved and dispersed in 120 mL of ethanol. An obtained liquid solution was bubbled with hydrogen gas at 70° C. so as to be reacted for 11 hours. A reaction end point was determined by means of thin layer chromatography. After completion of the reaction, a reaction mixture was thermally filtered, and then an obtained filtrate was dropped into water. This generated white precipitate. The white precipitate was stirred in the water for 12 hours. After the stirring, obtained powder was removed, sufficiently washed with water, and then dried at 80° C. for 12 hours under reduced pressure. Consequently, 3.2505 g of an EBMB crude product (yield: 89.9%) was obtained.

An obtained crude crystal was added to 280 mL of γ-butyrolactone and water (a ratio of the γ-butyrolactone to the water was 4:3), and dissolved at 100° C. To an obtained liquid solution was added an adequate amount of activated carbon. The liquid solution was stirred for a while, and then the activated carbon was removed from the liquid solution. Thereafter, the liquid solution was left for 12 hours, and then a crystal was collected. The crystal was dried in vacuum at 100° C. for 12 hours. Consequently, 1.7162 g of a product (recrystallization yield: 52.8%) was obtained.

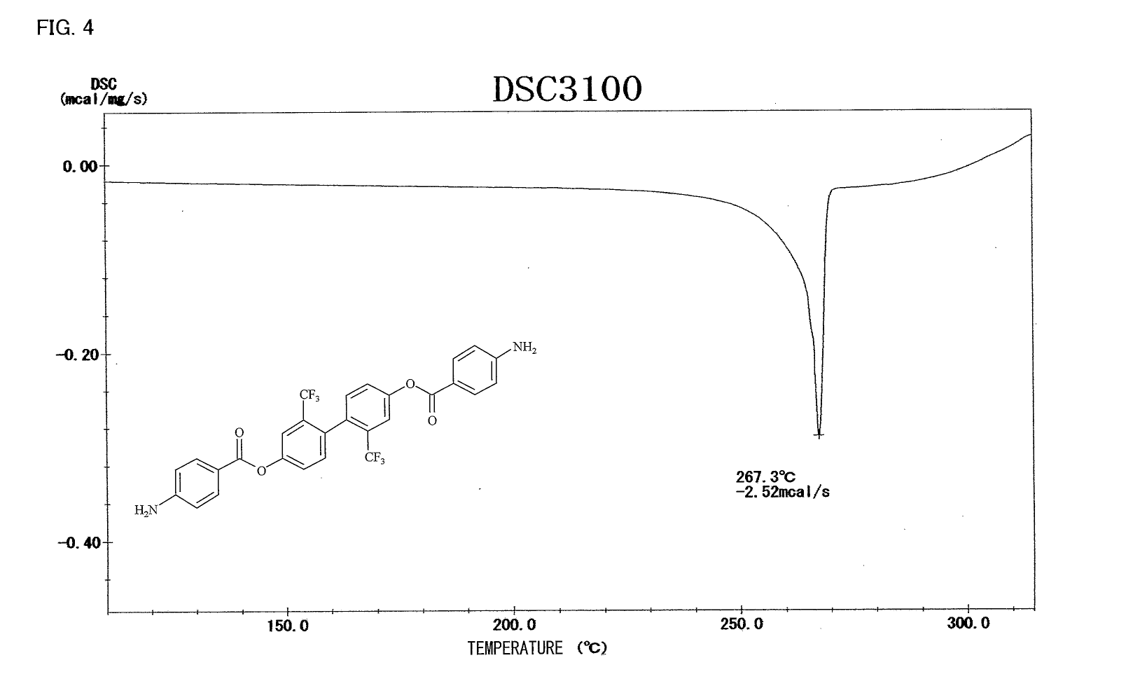

A melting point of the product was measured by use of the differential scanning calorimeter DSC3100 (manufactured by Bruker AXS K.K.), so that a steep heat-absorption peak was found at 267° C. (see FIG. 4). It was found that the product was a high-purity product.

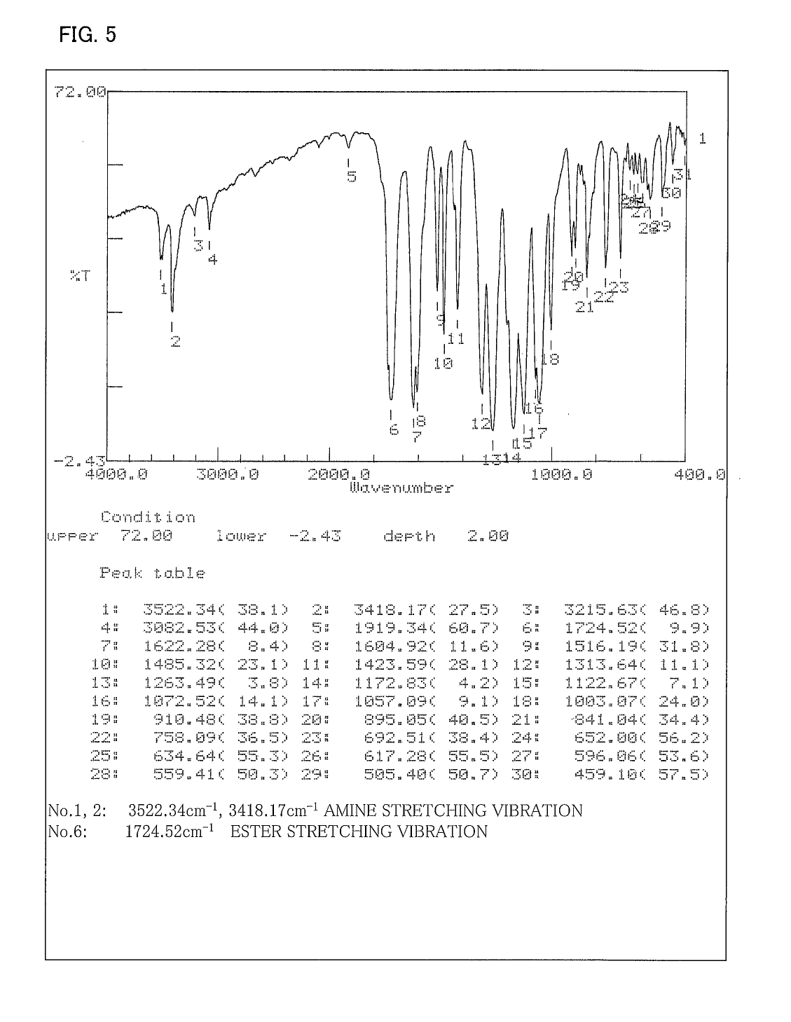

A KBr plate method was performed with respect to the product by use of the Fourier transform infrared spectrophotometer FT/IR5300 (manufactured by JASCO Corporation), so that amine stretching vibration was found at 3522 cm⁻¹ and 3418 cm⁻¹, and ester stretching vibration was found at 1724 cm⁻¹ (see FIG. 5).

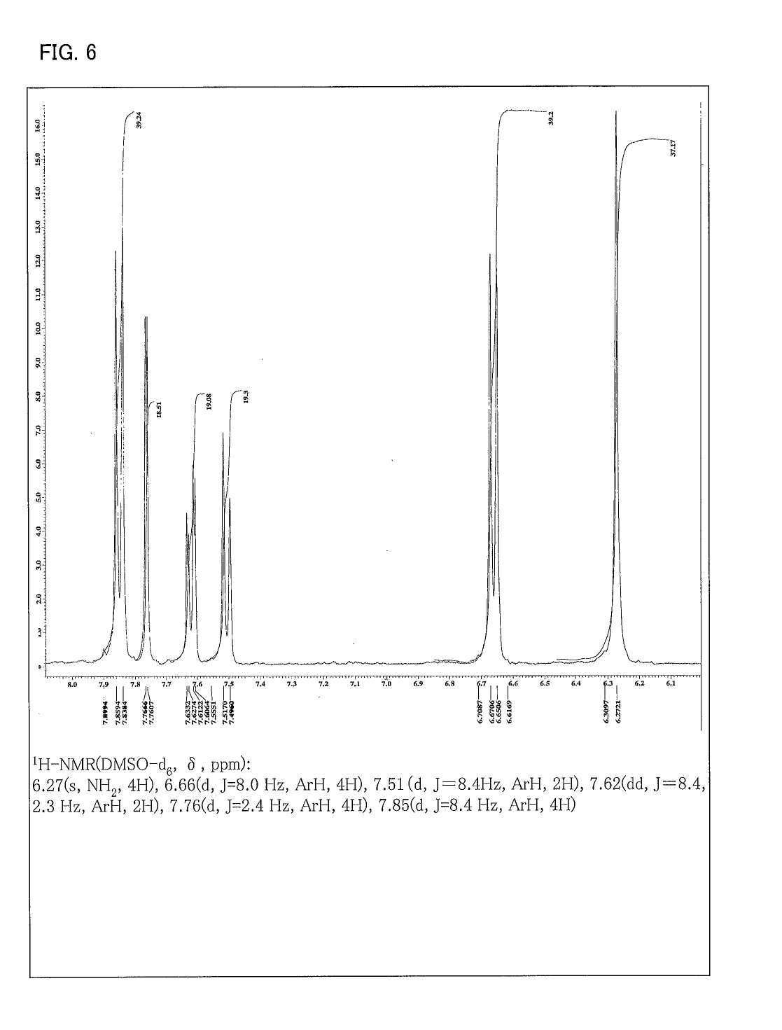

The product was subjected to proton NMR measurement by use of the Fourier transform nuclear magnetic resonance JNM-ECP400 (manufactured by JEOL Ltd.). Assignment results were as follows: (400 MHz, DMSO-d₆, δ, ppm): 6.27 (s, NH₂, 4H), 6.66 (d, J=8.0 Hz, ArH, 4H), 7.51 (d, J=8.4 Hz, ArH, 2H), 7.62 (dd, J=8.4 Hz, 2.3 Hz, ArH, 2H), 7.76 (d, J=2.4 Hz, ArH, 4H), 7.85 (d, J=8.4 Hz, ArH, 4H) (see FIG. 6). It was found that the product was a target product.

(Synthesis of Polyimide)

First, 0.8406 g (1.5 mmol) of EBMB and 0.8377 g (1.5 mmol) of ABMB were dissolved in 3.91 g of NMP. To an obtained liquid solution was added 0.6725 g (3 mmol) of H′-PMDA. NMP was further added to the liquid solution so that the liquid solution had a solid content concentration of 16.0 wt %. The liquid solution was stirred for 7 hours at room temperature. After the stirring, it was found that the liquid solution (polyimide precursor) had an intrinsic viscosity of 2.5 dL/g. Subsequently, a mixed solvent of 3.0627 g (30 mmol) of acetic anhydride and 1.1865 g (15 mmol) of pyridine was slowly dropped into the liquid solution at room temperature. A mixture of the mixed solvent and the liquid solution was stirred for 24 hours. After the stirring, a large amount of methanol was added to the mixture. This generated target white precipitate. The white precipitate was sufficiently washed with methanol, and then dried in vacuum.

### Comparative Example 1

First, 0.9607 g (3 mmol) of TFMB was dissolved in 3.8108 g of DMAc. To an obtained liquid solution was added 0.6725 g (3 mmol) of H′-PMDA. The liquid solution was stirred for 9 hours at room temperature, and then diluted with DMAc so that a diluted solution had a solid content concentration of 13.6 wt %. Subsequently, a mixed solvent of 3.0627 g (30 mmol) of acetic anhydride and 1.1865 g (15 mmol) of pyridine was added to the diluted solution at room temperature. A mixture of the mixed solvent and the diluted solution was stirred for 24 hours. The mixture was added to methanol. This generated target white precipitate. The white precipitate was sufficiently washed with methanol.

Obtained polyimide powder was dissolved in cyclopentanone so that a 15 wt % liquid solution was prepared. The liquid solution was spread over a glass substrate, and dried at 60° C. for two hours by use of a hot-air drier. The liquid solution thus dried was separated from the glass substrate, and further dried in vacuum at 250° C. for 1 hour. Consequently, a film was produced. Specifically, two kinds of film, i.e., a first film whose thickness was 16 μm and a second film whose thickness was 17 μm were produced. The first film was used to measure an average linear thermal expansion coefficient and a glass transition temperature of the first film. The second film was used to measure a light transmittance and a refractive index of the second film.

### Comparative Example 2

First, 0.7686 g (2.4 mmol) of TFMB and 0.1364 g (0.6 mmol) of DABA were dissolved in 3.6808 g of DMAc. To an obtained liquid solution was added 0.6725 g (3 mmol) of H′-PMDA. The liquid solution was stirred for 9 hours at room temperature. After the stirring, the liquid solution was diluted with DMAc so that a diluted solution had a solid content concentration of 12.4 wt %. Subsequently, a mixed solvent of 3.0627 g (30 mmol) of acetic anhydride and 1.1865 g (15 mmol) of pyridine was added to the diluted solution at room temperature. A mixture of the mixed solvent and the diluted solution was stirred for 24 hours. The mixture was added to methanol. This generated target white polyimide powder precipitate. The white precipitate was sufficiently washed with methanol.

The polyimide powder was dissolved in DMAc so that a 12 wt % liquid solution was prepared. The liquid solution was spread over a glass substrate, and dried at 60° C. for two hours by use of a hot-air drier. The liquid solution thus dried was separated from the glass substrate, and further dried in vacuum at 250° C. for 1 hour. Consequently, a film was produced. Specifically, two kinds of film, i.e., a first film whose thickness was 15 μm and a second film whose thickness was 20 μm were produced. The first film was used to measure an average linear thermal expansion coefficient and a glass transition temperature of the first film. The second film was used to measure a light transmittance and a refractive index of the second film.

### Comparative Example 3

First, 0.6725 g (2.1 mmol) of TFMB and 0.2045 g (0.9 mmol) of DABA were dissolved in 3.6155 g of DMAc. To an obtained liquid solution was added 0.6725 g (3 mmol) of H′-PMDA. The liquid solution was stirred for 9 hours at room temperature, and then diluted with DMAc so that a diluted solution had a solid content concentration of 12.5 wt %. Subsequently, a mixed solvent of 3.0627 g (30 mmol) of acetic anhydride and 1.1865 g (15 mmol) of pyridine was added to the diluted solution at room temperature. This generated a gelled reaction mixture. Therefore, it was not possible to conduct operations to be conducted after the addition of the mixed solvent to the diluted solution.

### Comparative Example 4

First, 0.5764 g (1.8 mmol) of TFMB and 0.2727 g (1.2 mmol) of DABA were dissolved in 3.5504 g of DMAc. To an obtained liquid solution was added 0.6725 g (3 mmol) of H′-PMDA. The liquid solution was stirred for 9 hours at room temperature, and then diluted with DMAc so that a diluted solution had a solid content concentration of 12.5 wt %. Subsequently, a mixed solvent of 3.0627 g (30 mmol) of acetic anhydride and 1.1865 g (15 mmol) of pyridine was added to the diluted solution at room temperature. This generated a gelled reaction mixture. Therefore, it was not possible to conduct operations to be conducted after the addition of the mixed solvent to the diluted solution.

### Comparative Example 5

First, 0.6818 g (3 mmol) of DABA was dissolved in 3.160 g of DMAc. To an obtained liquid solution was added 0.6725 g (3 mmol) of H′-PMDA. The liquid solution was stirred for 9 hours at room temperature, and then diluted with DMAc so that a diluted solution had a solid content concentration of 12.5 wt %. Subsequently, a mixed solvent of 3.0627 g (30 mmol) of acetic anhydride and 1.1865 g (15 mmol) of pyridine was added to the diluted solution at room temperature. This generated an insoluble component. Therefore, it was not possible to conduct operations to be conducted after the addition of the mixed solvent to the diluted solution.

Table 1 shows a polymerization concentration, an intrinsic viscosity of a polyamic acid solution, an intrinsic viscosity of a polyimide, and a refractive index in each of Examples 2 and 4 and Comparative Examples 1 through 5.

TABLE 1

| | | | Intrinsic Viscosity | | | | |
|---|---|---|---|---|---|---|---|
| | | | Polyamic | | | | |
| | Concentration | | acid | Polyimide | Refractive Index | | |
| | Polymerization | Imidization | solution | solution | | Out of | |
| | [wt %] | [wt %] | [dL/g] | [dL/g] | In-Plane | Plane | Average |
| Example 2 | 30 | 10.2 | 7.1 | 4.9 | 1.6342 | 1.5035 | 1.5906 |
| Example 4 | 30 | 10.0 | 6.1 | 2.8 | Unmeasured | Unmeasured | Unmeasured |
| Comparative | 30 | 13.6 | 4.2 | 2.1 | 1.5598 | 1.532 | 1.5505 |
| Example 1 | | | | | | | |
| Comparative | 30 | 12.4 | 4.1 | 4 | 1.5779 | 1.5312 | 1.5623 |
| Example 2 | | | | | | | |
| Comparative | 30 | 12.5 | Unmeasured | Gelation | — | — | — |
| Example 3 | | | | | | | |
| Comparative | 30 | 12.5 | Unmeasured | Gelation | — | — | — |
| Example 4 | | | | | | | |
| Comparative | 30 | 12.5 | Unmeasured | precipitation | — | — | — |
| Example 5 | | | | | | | |

Table 2 shows evaluation of the solution processability of the polyimide obtained in each of Examples 2 and 5 and Comparative Examples 1 and 2.

In Table 2, DMSO represents dimethylsulfoxide.

The polyimides obtained in respective Examples 2 and 5 were dissolvable in various solutions, and had solution processabilities more excellent than those of the polyimides obtained in respective Comparative Examples 1 and 2. The solution processability of the polyimide obtained in Example 5 was more excellent than that of the polyimide obtained in Example 2.

TABLE 2

| | | | Comparative | Comparative |
|---|---|---|---|---|
| | Example 2 | Example 5 | Example 1 | Example 2 |
| Chloroform | − | − | − | − |
| Acetone | − | − | − | − |
| THF | − | − | − | − |
| 1,4-dioxane | − | ± | − | − |
| Ethyl acetate | − | ± | − | − |
| Cyclopentanone | ++ | ++ | ++ | − |
| Cyclohexanone | ++ | ++ | ++ | − |
| DMAc | ++ | ++ | ++ | + |
| N-methyl-2- | ++ | ++ | ++ | + |
| pyrrolidone | | | | |
| DMSO | + | ++ | ++ | + |
| γ-butyrolactone | + | ++ | + | ± |

“++”: dissolve at room temperature,
“+”: thermally dissolve,
“±”: swell or partially dissolve,
“−”: undissolve

Table 3 shows a Tg, a Td5, a CTE, and a light transmittance of the film of each of Examples 2 through 4 and Comparative Examples 1 and 2.

TABLE 3

| | | | | | Optical characteristic | | |
|---|---|---|---|---|---|---|---|
| | Thermal characteristic | | | | | Light | |
| | Film | | | | Film | transmittance | Cut off |
| | Thickness | Tg | Td5 | CTE | Thickness | at wavelength | Wavelength |
| | [μm] | [° C.] | [° C.] | [ppm/K] | [μm] | of 400 nm [%] | [nm] |
| Example 2 | 10 | 370 | 426 | 24.0 | 15 | 75.9 | 329.5 |
| Example 3 | 10 | 370 | 426 | 15.7 | 15 | 76.2 | 329.5 |
| Example 4 | 28 | 370 | 422 | 19.9 | 20 | 82.0 | 338.5 |
| Comparative | 16 | 364 | 476 | 52.4 | 17 | 89.5 | 294.5 |
| Example 1 | | | | | | | |
| Comparative | 15 | 362 | 462 | 43.6 | 19 | 81.8 | 337.0 |
| Example 2 | | | | | | | |

The films of Examples 2 through 4 had a higher Tg, a lower CTE, and a lower Td5 than the films of Comparative Examples 1 and 2. The films of Examples 2 through 4 had satisfactory light transmittances substantially equal to those of the films of Comparative Examples 1 and 2.

### INDUSTRIAL APPLICABILITY

For example, a film of a polyimide of the present invention is suitably used in a substrate, a color filter, a printed material, an optical material, an electronic device, an image display device, etc. The polyimide of the present invention can be produced by a suitable use of a diamine of the present invention.

1. A diamine represented by formula (1) 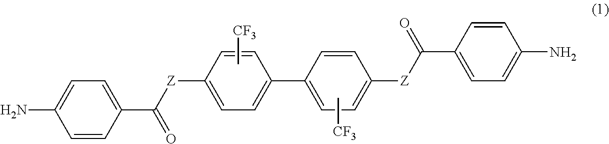
where z represents NH or O.

2. The diamine as set forth in claim 1, wherein the diamine is represented by formula (2).

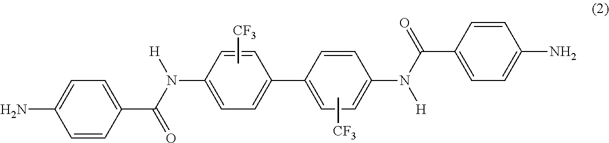

3. A polyimide having a repeating unit represented by formula (3) 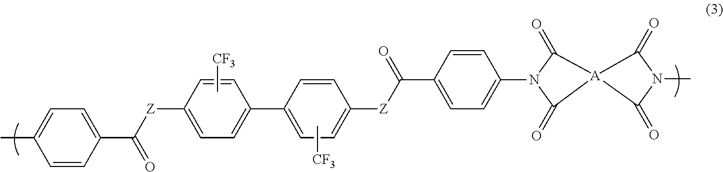
where A represents a tetravalent aliphatic group, and z represents NH or O.

4. The polyimide as set forth in claim 3, wherein the polyimide has a repeating unit represented by formula (4) 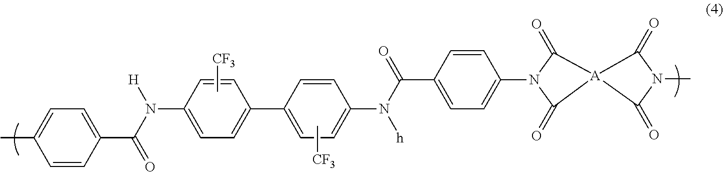
where A represents a tetravalent aliphatic group.

5. The polyimide as set forth in claim 3, wherein the polyimide has a repeating unit represented by formula (5) 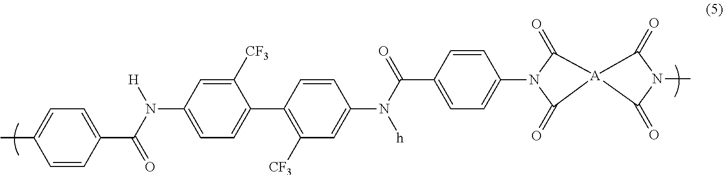
where A represents a tetravalent aliphatic group.

6. The polyimide as set forth in claim 3, wherein the polyimide has a repeating unit represented by formula (6).

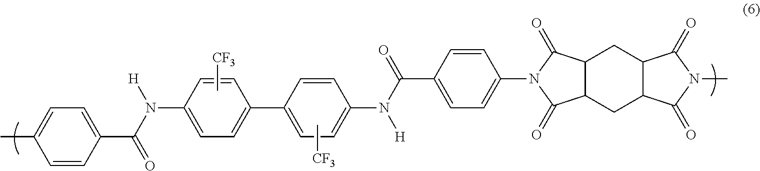

7. The polyimide as set forth in claim 3, wherein the polyimide further has a repeating unit represented by formula (7) 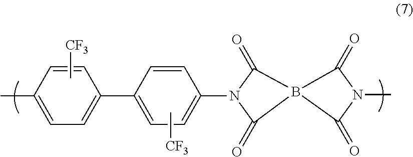
where B represents a tetravalent aliphatic group.

8. A polyimide film of a polyimide as set forth in claim 3.

9. A substrate comprising a polyimide film as set forth in claim 8.

10. A color filter comprising a polyimide film as set forth in claim 8.

11. An image display device comprising a polyimide film as set forth in claim 8.

12. An optical material comprising a polyimide film as set forth in claim 8.

13. An electronic device comprising a polyimide film as set forth in claim 8.
